(19) United States
(12) Patent Application Publication
(10) Pub. No.: US 2019/0245300 A1
(43) Pub. Date: Aug. 8, 2019

(54) DRESS COVER WITH TAPE AND TIE FEATURE

(71) Applicant: Sumitomo Wiring Systems, Ltd., Yokkaichi (JP)

(72) Inventors: Danielle Irish, Farmington Hills, MI (US); Eric Torrey, Farmington Hills, MI (US)

(21) Appl. No.: 15/888,780

(22) Filed: Feb. 5, 2018

(51) Int. Cl. H01R 13/58

(52) U.S. Cl. CPC H01R 13/5841; H01R 13/5812

(57) ABSTRACT

A connector housing assembly and a dress cover configured to provide multiple wire routing options are provided. The dress cover includes an exit path defining a path for which the wire bundle is routed. The dress cover further includes a tie feature and a tape feature. The tape feature is a generally planar member extending from an outer peripheral side of a back wall and is orthogonal to the plane of a first side wall of the dress cover and is coplanar with the exit path. The tie feature is mounted on the first side wall and is adjacent the exit path. The tie feature is disposed above a plane of the exit path so as to allow the tied bundle of wire to be tied along the plane of the exit path.

### TECHNICAL FIELD

The specification generally relates to a connector housing assembly and in particular to a connector housing assembly having a dress cover configured to maintain the structural integrity of a wire bundle.

### BACKGROUND

In general, dress covers are used to cover a connector housing. The connector housing includes a plurality of terminal openings configured to receive a plurality of wires. The wires are bundled together and are protected by the dress cover. The wires are bundled together so as to form a wire bundle. The wire bundle is routed through an exit path of the dress cover.

The wire bundle is secured to the dress cover so as to stabilize the wire bundle and prevent the wire bundle from additional bending or flexing which could potentially break the wires. Currently, dress covers are configured to have either a tape feature or a tie feature for securing the wire bundle to the dress cover. This requires specific manufacturing. That is, currently dress covers are manufactured with either a tape feature or a tie feature.

Further, current dress covers are configured with tape or tie features which route the wire bundle upwardly or downwardly with respect to the exit path, forming an additional bend in the wire bundle. Further, current tie features require the installer to route the tie through a slit to tie the wire bundle to the dress cover. To some installers, routing the tie through a slit requires the same dexterity as threading the eye of a needle.

Accordingly, it remains desirable to have a dress cover that provides the installer the option of either taping or tying the wire bundle to the dress cover so as to prevent the manufacturing of two different dress covers. It further remains desirable to have a tie feature which facilitates tying the wire bundle to the dress cover. It further remains desirable to have a dress cover with tape and tie features which are axially aligned with the exit path so as to prevent additional bends in the wire bundle.

### SUMMARY

In one embodiment a dress cover is configured to provide the installer with the option of either tying or taping the wire bundle to the dress cover and maintain the wire bundle along a single plane so as to minimize the number of bends in the wire bundle.

The dress cover includes a first side wall, a second side wall, a first back wall and a first top wall connected to each other so as to define a storage space. The dress cover includes an exit path disposed between the first back wall and the first side wall. The exit path defines a path for which the wire bundle is routed. The dress cover includes an engagement feature configured to engage a connector housing.

The dress cover further includes a tie feature and a tape feature. The tape feature is a generally planar member extending from an outer peripheral side of the back wall, orthogonal to the plane of the first side wall and is coplanar with the exit path. The tie feature is mounted on the first side wall and is adjacent the exit path. The tie feature is disposed above a plane of the exit path so as to allow the tied bundle of wire to be tied along the plane of the exit path.

In one embodiment of a tie feature the tie feature includes a housing having support portion and a leg portion. The support portion is fixed to the first side wall. The leg portion is disposed beneath the support portion and is spaced apart from the support portion and the wall so as to define a slot with an open end. In one embodiment, the leg portion includes a catch configured to retain a tie in the slot.

Accordingly, the dress cover is configured to provide the installer with the option of either tying or taping the wire bundle, thus eliminating the need for manufacturing different dress covers. Further, the tape and tie features are coplanar with the exit path so as to minimize the number of bends needed to secure the wire bundle to the dress cover. Further, the tie feature is configured to facilitate tying the wire bundle to the tie feature.

### BRIEF DESCRIPTION OF THE DRAWINGS

The embodiments set forth in the drawings are illustrative and exemplary in nature and not intended to limit the subject matter defined by the claims. The following description of the illustrative embodiments can be understood when read in conjunction with the following drawings where like structure is indicated with like reference numerals and in which:

FIG. 1 is an exploded view of a connector housing assembly showing a dress cover in accordance with one or more embodiments described and illustrated herein;

FIG. 1A is a cross-sectional view showing the catch engaged with the tab;

FIG. 2 is an assembled view of the connector housing assembly shown in FIG. 1.

FIG. 3 is a top down view showing the dress cover connected to the connector housing with the wires taped to the tape feature;

FIG. 4 is a top down view showing the dress cover connected to the connector housing with the wires tied to the tie feature;

FIG. 5 is an isolated view taken from the side of the dress cover, showing the wire bundle tied to the tie feature;

FIG. 6 is view of FIG. 5 take from the front showing the open end of the slot; and

FIG. 7 is an embodiment of a dress cover with two exit paths.

### DETAILED DESCRIPTION OF THE PREFERRED EMBODIMENTS

Referring generally to the figures, embodiments of the present disclosure include a connector housing assembly having a dress cover configured to provide the installer with the option of either tying or taping the wire bundle to the dress cover and maintain the wire bundle along a single plane so as to minimize the number of bends in the wire bundle. The dress cover includes a first side wall, a second side wall, a first back wall and a first top wall connected to each other so as to define a storage space for accommodating a wire bundle. The dress cover further includes an exit path disposed between the first back wall and the first side wall. The exit path defines a path for which the wire bundle is routed.

The tape feature is a generally planar member extending from an outer peripheral side of the back wall, orthogonal to the plane of the first side wall and is coplanar with the exit path. The tie feature is mounted on the first side wall and is adjacent the exit path and above a plane of the exit path. The tie feature is disposed above the plane of the exit path so as to position a tied wire bundle along the plane of the exit path. Thus, in either instance, the wire bundle is contained to the same plane, thus minimizing the number of bends formed in the wire bundle.

The tie feature includes a slot with an open end so as to facilitate tying the wire bundle to the dress cover. In particular, the installer may use a tie having a loop, such as a zip tie to tie the wire bundle to the tie feature. In such a case, the loop is simply introduced into the open end of the slot and cinched onto the tie feature securing the wire bundle to the dress cover. Accordingly, the dress cover is configured to provide the installer with the option of either tying or taping the wire bundle, thus eliminating the need for manufacturing different dress covers. Further, the tape and tie features are coplanar with the exit path so as to minimize the number of bends needed to secure the wire bundle to the dress cover. Further, tying the wire bundle to the tie feature is easier relative to routing the tie through a closed slit as is currently done.

As used herein, the terms “top” and “bottom” refer to the orientation of the referenced part shown in the referenced figure. The term “front” refers to the portion of the part in which an electrical connection is made between two terminals and the term “back” refers to the portion of the part in which the wires of the terminals are routed. The term “installer” refers to a person who routes wire through the connector assembly and mounts the connector assembly into a packaging space.

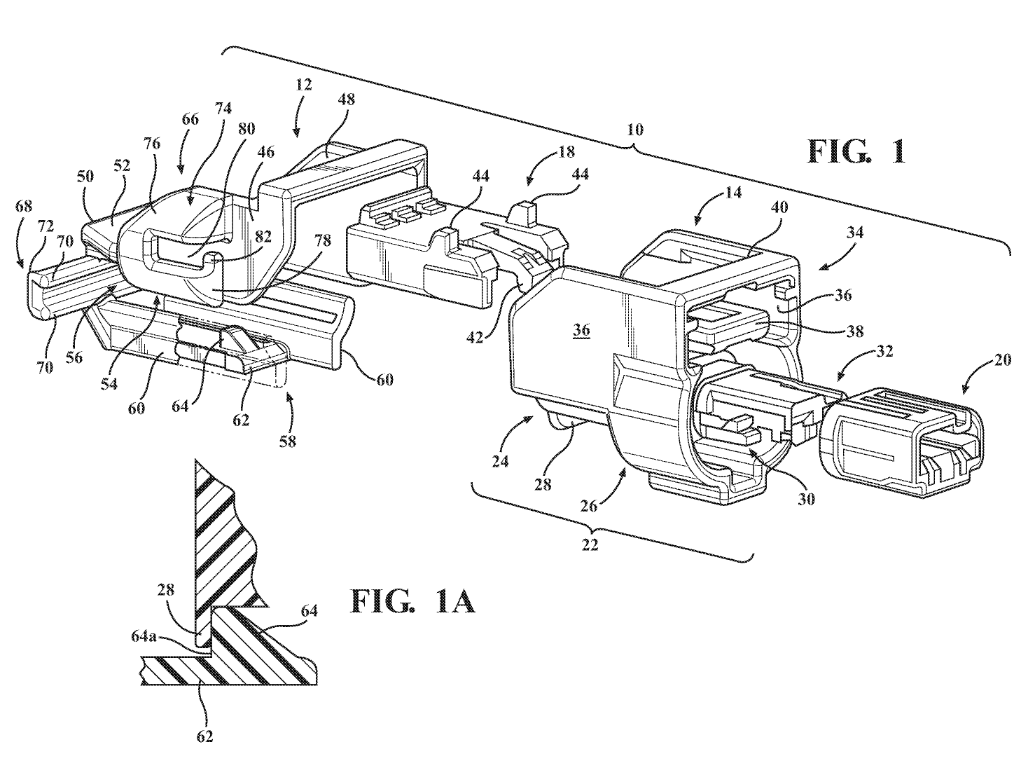

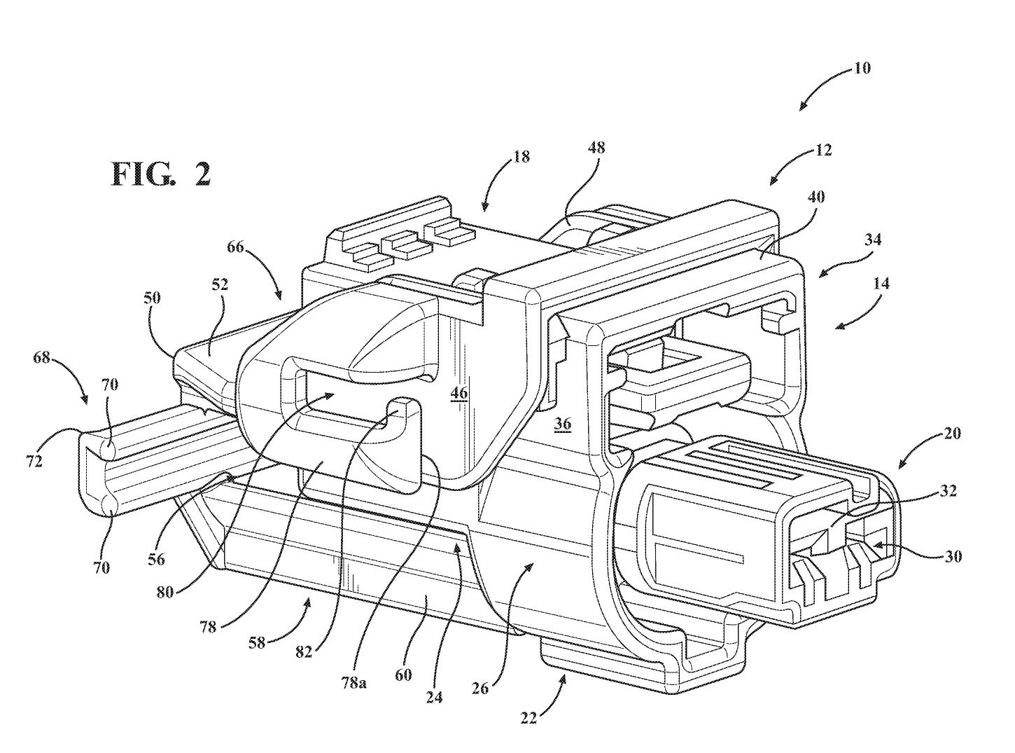

With reference now to FIGS. 1, 1A and 2 an illustrative depiction of a connector housing assembly 10 is provided. FIG. 1 is an exploded view a connector housing assembly 10. FIG. 2 is a view showing the connector housing assembly 10 assembled. The connector housing assembly 10 includes a dress cover 12 and a connector housing 14. The connector housing 14 is configured to couple with another connector housing 14 so as to couple a male connector terminal (not shown) with a female connector terminal 16 in an inline manner. As used herein the term “inline” refers to an electrical connection of a male connector terminal to a female connector terminal along a common axis. The connector housing 14 and the dress cover 12 may be formed of a durable and resilient material suitable for use in the injection molded process, such material illustratively includes polypropylene.

For illustrative purposes, the connector housing 14 is shown as a female connector housing 14 configured to house a female connector terminal 16. However, it should be appreciated that the connector housing 14 may be a male connector housing configured to house a male connector terminal. The connector housing assembly 10 is also illustratively shown as having a connector positioning assurance member 18 and a terminal positioning assurance member 20. However, it should be appreciated that the connector positioning assurance member 18 and the terminal positioning assurance members 20 are provided for illustrative purposes and are not limiting to the scope of the appended claims.

The connector housing 14 includes a housing body 22 configured to receive at least one connector terminal (male or female). In one embodiment, the housing body 22 includes a locking portion 24 and a terminal housing portion 26. The locking portion 24 and the terminal housing portion 26 may be integrally formed as a single unit. The locking portion 24 is a generally cylindrical member and includes a locking tab 28. The locking tab 28 is shown disposed on a bottom surface of the locking portion 24. The locking tab 28 is a planar member made of a resilient material. The locking tab 28 extends generally the width of the connector housing 14.

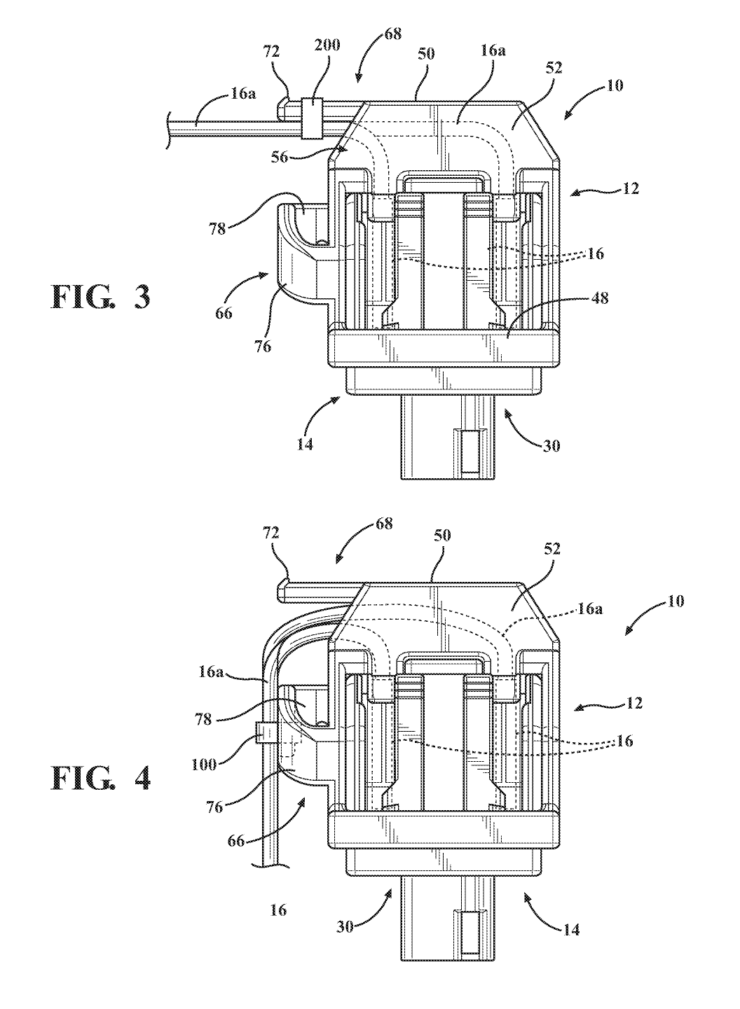

The dress cover 12 is configured to couple with the connector housing 14. The connector housing 14 is configured to accommodate a connector terminal. For illustrative purposes, FIGS. 3 and 4 show the connector terminal being a female connector terminal 16. The female connector terminal 16 is coupled to a wire 16a which is routed through a back end of the connector housing 14. The dress cover 12 protects the wire 16a and assists in routing the wire 16a away from areas which may be detrimental to the operation of the wire 16a. For instance, the connector housing 14 may be used in an environment where heat is generated. In such instances, it is desirable to route the wire 16a away from the heat source. In another example, the connector housing 14 may be used in an environment subject to vibration, in such a case the wire 16a is routed from the source of the vibration.

The terminal housing portion 26 is a generally cylindrical body with at least one through-hole which defines a terminal opening 30. The terminal opening 30 is configured to receive a connector terminal. It should be appreciated that the terminal opening 30 may vary in size to accommodate a connector terminal of a predetermined diameter. It should be further appreciated that the terminal opening 30 may be dimensioned to accommodate a plurality of connector terminals, and may be further configured to accommodate connector terminals of different diameters.

A retention feature 32 is disposed within the terminal opening 30 to hold a connector terminal. In the instant case, the terminal opening 30 is configured to hold a pair of female connector terminals 16 in a side-by-side configuration. For illustrative purposes the terminal housing portion 26 is shown as accommodating a pair of wires 16a having a diameter of 1.2 mm. However, it should be appreciated that the terminal housing portion 26 may be configured to accommodate one wire 16a or more wires 16a, and the dimensions of the wire 16a may be more or less than 1.2 mm.

In embodiments where a connector positioning assurance member 18 is included, the connector housing 14 may further include a CPA support 34. The CPA support 34 is disposed on a top surface of the locking portion 24 and the terminal housing portion 26 and is configured to receive a connector positioning assurance member 20. The CPA support 34 includes a pair of guide walls 36 spaced apart from each other and a locking base 38. A CPA stop 40 is disposed on front end of the pair of guide walls 36 and interconnects the top of the respective guide walls 36. The connector positioning assurance member 18 includes a locking leg 42 configured to snap onto the locking base 38. The connector positioning assurance member 18 includes a pair of locking ribs 44. The pair of locking ribs 44 engage the CPA stop 40, securing the connector positioning assurance member 18 to the CPA support 34. The CPA support 34 may be configured to engage the connector positioning assurance member 20 in a snap-fit engagement as illustratively shown in FIG. 2, wherein the connector positioning assurance member 18 is seated between the pair of guide walls 36.

In embodiments, where a terminal positioning assurance member 20 is included, the retention feature 32 of the housing body 22 may be configured to receive the terminal positioning assurance member 20. The terminal positioning assurance member 20 engages the retention feature 32 in a snap fit engagement so as to form through-holes dimensioned to receive the connector terminal(s). Thus, the connector terminal(s) is/are properly seated and secured so as to couple with a respective male or female terminal, as the case may be, to complete an electric connection.

With reference again to FIGS. 1 and 2 and now to FIG. 3, an illustrative depiction of the dress cover 12 is provided. The dress cover 12 includes a first side wall 46, a second side wall 48, a first back wall and a first top wall 52 connected to each other so as to define a storage space 54. The dress cover 12 includes an exit path 56 disposed between the first back wall 50 and the first side wall 46. The exit path 56 defines a path for which the wire 16a is routed, as shown in FIGS. 3 and 4. The dress cover 12 includes an engagement feature 58 configured to engage a connector housing 14. The first back wall 50 is configured to be spaced apart from the connector housing 14 so as to define a storage space 54 having a predetermined wire bend radius so as to reduce stress on the wire 16a routed from the exit path 56.

The engagement feature 58 is illustratively shown as a pair of support arms 60 extending orthogonal from the first back wall 50 and disposed underneath a respective first and second side walls 46, 48 of the dress cover 12. A support floor 62 is disposed between each of the pair of support arms 60. The support floor 62 includes a first catch 64. The first catch 64 is general ramp shaped and includes a back wall 64a which is generally orthogonal to the support floor 62. The support arm 60 has an inner wall surface which is configured to seatingly engage a predetermined outer surface of the housing body 22. As the housing body 22 is cylindrical, the inner wall surface is arcuate and dimensioned to cradle opposite sides of the housing body 22. The first catch 64 is configured to engage the locking tab 28 of the housing body 22 so as to secure the dress cover 12 to the housing body 22.

The exit path 56 is a passage formed by the coupling of the dress cover 12 to the connector housing 14. The exit path 56 allows for wires (not shown) from the connector terminal (not shown) to be routed. The exit path 56 is defined by the space between the inner surface of the first top wall 52 of the dress cover 12, the back surface of the connector housing 14 and the space between a bottom surface of the first side wall 46 and a top surface of the support arm 60.

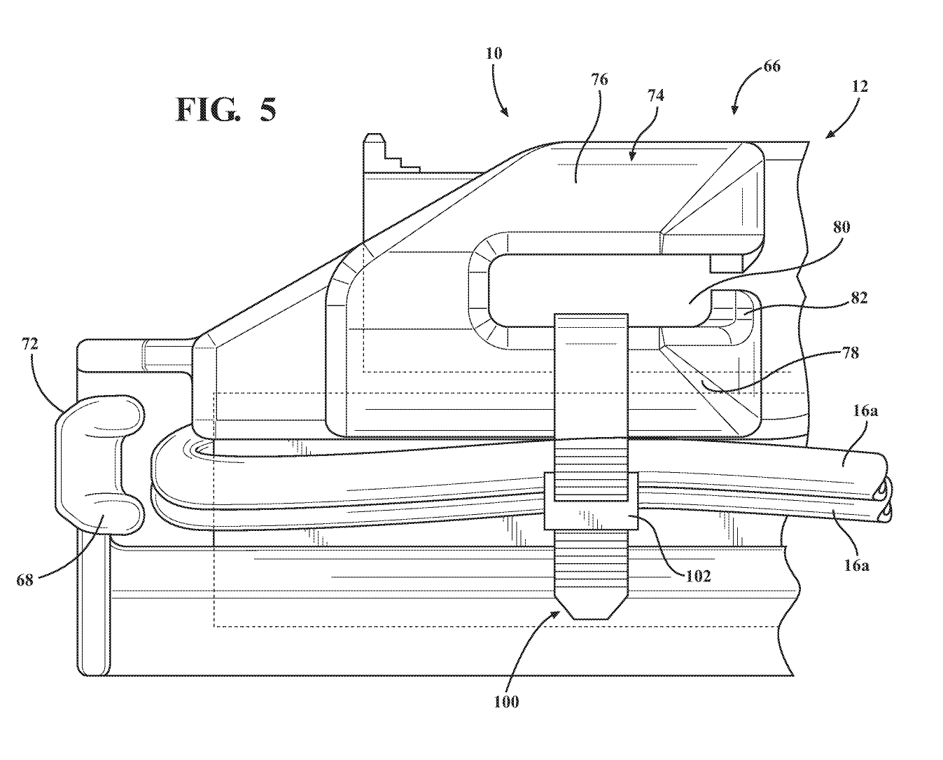

With reference now to FIGS. 2-6, the dress cover 12 further includes a tie feature 66 and a tape feature 68. The tape feature 68 is a generally planar and elongated member extending from an outer peripheral side of the first back wall 50 of the dress cover 12. The tape feature 68 is orthogonal to the plane of the first side wall 46 and is coplanar with the exit path 56. The tape feature 68 is illustratively shown as an elongated member integrally formed to the first back wall 50. It should be appreciated that the length of the tape feature 68 shown in the drawings are provided for illustrative purposes and is not limiting to the scope of the appended claims.

The tape feature 68 may include a pair of guide ribs 70 extending along the axial length of the elongated member. The guide ribs 70 are disposed on the inner surface of the tape feature 68 and spaced apart from each other so as to form a generally arcuate surface. A tape stop 72 may be formed adjacent the distal end of the tape feature 68. The tape stop 72 is illustratively shown being disposed on a back surface of the tape feature 68, but it should be appreciated that the tape stop 72 may be located on the sides of the tape feature 68 or the bottom surface of the tape feature 68 without deviating from the scope of the appended claims.

The tie feature 66 is mounted on the first side wall 46 and is adjacent the exit path 56. The tie feature 66 is disposed above a plane of the exit path 56 so as to allow the tied bundle of wire 16a to be tied and hang along the plane of the exit path 56. The tie feature 66 is further configured to facilitate tying the wire 16a to the dress cover 12.

In one embodiment of a tie feature 66 the tie feature 66 includes a tie housing 74. The tie housing 74 has a generally arcuate outer surface and includes a support portion 76 and a leg portion 78. The support portion 76 is fixed to the first side wall 46. The leg portion 78 is disposed beneath the support portion 76. An inner wall 78a surface of the leg portion 78 is spaced apart from the support portion 76 and the first side wall 46 so as to define a slot 80 with an open end. In one embodiment, the leg portion 78 includes a second catch 82 configured to retain a tie 100 in the slot 80.

With reference now to FIG. 8, a second embodiment of the connector housing assembly 10 is provided. The dress cover 12 further includes a first tie feature 66a, a second tie feature 66b, a first tape feature 68a and a second tape feature 68b. The dress cover 12 further includes a first exit path 56a and a second exit path 56b. The first exit path 56a is disposed between the first back wall 50 and the first side wall 46. The second exit path 56b is disposed between the first back wall 50 and the second side wall 48. The connector housing assembly 10 of the second embodiment provides for additional wiring routing options relative to the first embodiment described above. For instance, the installer has the option of routing the wires 16a through the first tape feature 68, the second tape feature 68, the first tie feature 66 or the second tie feature 66 or any combination thereof.

The first tape feature 68a and the second tape feature 68b are generally planar members extending opposite each other from opposing outer peripheral sides of the first back wall 50. The first and second tape features 68a, 68b are both orthogonal to the plane of the first side wall 46 and second side wall 48 respectively and are both coplanar with respective first and second exit paths 56a, 56b. The first and second tape features 68a, 68b are illustratively shown as an elongated member integrally formed to the first back wall 50. It should be appreciated that the length of the first and second tape features 68a, 68b shown in the drawings are provided for illustrative purposes and is not limiting to the scope of the appended claims.

The first and second tape features 68a, 68b may each include a pair of guide ribs 70 extending along the axial length of the elongated member. The guide ribs 70 are disposed on the inner surface of the first and second tape features 68a, 68b and forms a generally arcuate surface. A tape stop 72 may be formed adjacent the distal end of the first and second tape features 68a, 68b. The tape stop 72 is illustratively shown being disposed on a top surface of the tape feature 68, but it should be appreciated that the tape stop 72 may be located on the sides of the tape feature 68 or the bottom surface of the tape feature 68 without deviating from the scope of the appended claims.

The first and second tie features 66a, 66b are mounted on the first side wall 46 and the second side wall 48 respectively. The first and second tie features 66a, 66b are adjacent respective exit paths 56a, 56b. The first and second tie features 66a, 66b are disposed above a plane of the respective exit paths 56a, 56b so as to allow the tied bundle of wire 16a to be tied and hang along the plane of the respective exit paths 56a, 56b. The first and second tie features 66a, 66b are similar to each other, and thus a description of the second tie feature 66 is provided in reference to the description of the tie feature 66 disclosed above.

In operation, the installer slides the female connector terminal 16 into the terminal opening 30 of the connector housing 14. In the instant case, as the connector housing 14 is configured to house a female connector terminal 16. The dress cover 12 is mounted onto the locking portion 24 of the housing body 22. The support arms 60 of the dress cover 12 slide against opposing sides of the locking portion 24, and the floor of the engagement feature 58 slides beneath the locking tab 28. As the dress cover 12 is seated, the first catch 64 of the support floor 62 engages the locking tab 28, causing the support floor 62 to expand away from the locking tab 28. As the first catch 64 passes the locking tab 28, the support floor 62 returns to a natural state, wherein the back wall 64a of the first catch 64 engages the locking tab 28 securing the dress cover 12 to the locking portion 24 of the connector housing 14. The wire 16a of the female connector terminal 16 is then routed through the exit path 56.

At this point, the installer has the option of routing the wire 16a along the tape feature 68 or the tie feature 66. Routing the wire 16a may be determined by the packaging constraints of the connector housing assembly 10, or to position the wire 16a away from a detrimental environment such as a source of heat or vibration. When it is desirable to route the wire 16a along the tape feature 68, the wires 16a of the female connector terminals 16 are simply aligned along the tape feature 68 and secured thereto using tape 200. Reference is now made to FIG. 3 which shows the wires 16a taped to the elongated member. Preferably, the tape 200 is closed about the tape feature 68 and the wires 16a of the female connector terminals 16 so as to tightly secure the wires 16a to the tape feature 68. The tape 200 is taped between the tape stop 72 and the first back wall 50, wherein the tape stop 72 prevents the tape 200 from sliding off the tape feature 68. Thus, the wire 16a bundle is laid along the same plane as the exit path 56.

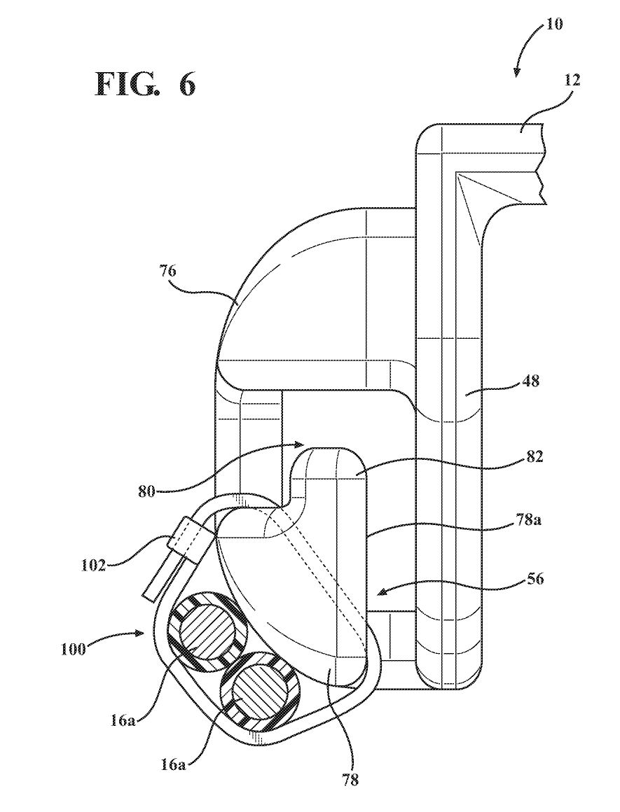

With reference now to FIGS. 4-6, a description of the tie feature 66 is provided. In some instances, it may be desirable to route the wire 16a along the first side wall 46. In such an instance, the installer may use a tie 100. For illustrative purposes, the tie 100 is shown as a cable tie commonly known as a “zip tie.” The zip-tie 100 is generally an elongated flexibly member with a plurality of teeth (not shown) and includes a securing house 102 having a finger (not shown) for engaging the teeth. The securing house 102 is disposed on one end of the zip tie 100 and is opposite a free end. The free end is inserted into the securing housing 102 so as to form a loop (seen in FIG. 6). The wire 16a bundle is routed through the loop and the loop is inserted onto the leg portion 78 of the tie feature 66 through the open end of the slot 80. The zip tie 100 is then cinched. Preferably, as shown in FIG. 6, the wires 16a are cinched so as to remain on the same plane as the exit path 56. Preferably, the zip tie 100 is disposed behind the second catch 82, wherein the zip tie 100 is prevented from coming off of the leg portion 78.

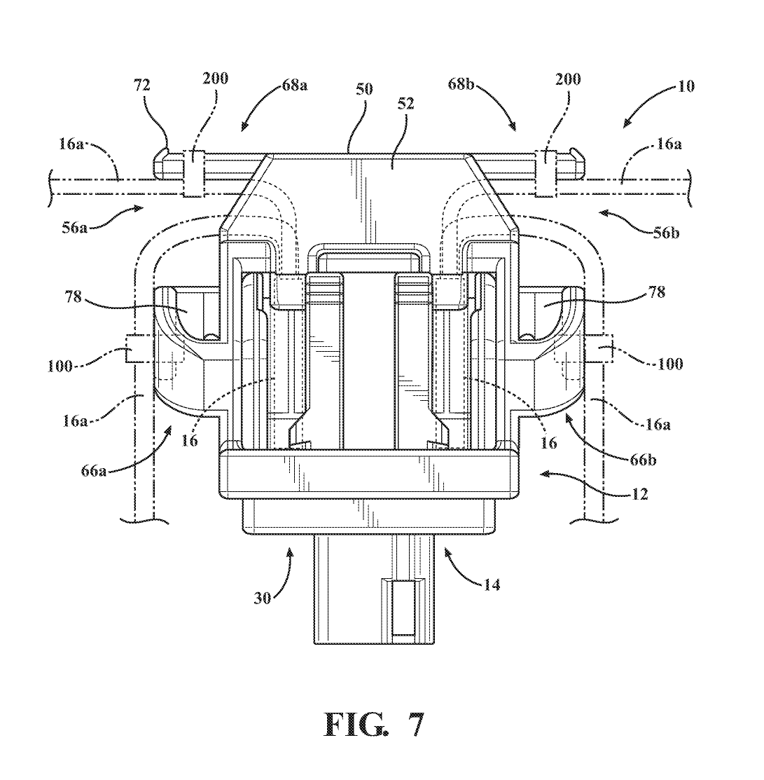

With reference now to FIG. 7, a description of the operation of the second embodiment of the connector housing 14 is provided. In the second embodiment, the operation of securing the wire 16a to the tape feature 68 or the tie feature 66 is made in reference to the description disclosed above. The second embodiment shows how the installer is provided with additional options for routing the wire 16a along the second side wall 48 of the dress cover 12 assembly in addition to the first side wall 46 as described above. The wires 16a are shown bundled together in broken lines through both the first and the second exit paths 56a, 56b along the first tape feature 68, the second tape feature 68, the first tie feature 66 and the second tie feature 66 to illustrate the routing flexibility provided.

Accordingly, the connector assembly is configured to provide multiple routing options so as to eliminate the need for the manufacture of multiple dress covers 12. Further, the dress cover 12 is configured with a tape feature 68 and a tie feature 66 which helps keep the wire 16a bundle on the same plane thus reducing stress on the wire 16a bundle.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A connector housing assembly configured to provide multiple routing options for a wire connected to a terminal connector, the connector housing assembly comprising:
a connector housing configured to house the terminal connector;
a dress cover configured to engage the connector housing, the dress cover having a first side wall, a second side wall, a first back wall and a first top wall connected to each other so as to define a storage space for accommodating the wire, the dress cover further including an exit path disposed between the first back wall and the first side wall, the exit path defines a path for which the wire is routed; and
a tape feature and a tie feature, the tape feature is a generally elongated and planar member extending from an outer peripheral side of the back wall, orthogonal to the plane of the first side wall and is coplanar with the exit path, the tie feature is mounted on the first side wall and spaced apart from the back wall, the tie feature is adjacent the exit path and above a plane of the exit path, the tie feature is disposed above the plane of the exit path so as to position a tied wire bundle along the plane of the exit path and parallel to the first side wall, accordingly, the dress cover provides multiple wire routing options for the wire.

2. The connector housing assembly as set forth in claim 1, wherein the tape feature includes a pair of guide ribs extending along an axial length of the elongated member.

3. The connector housing assembly as set forth in claim 2, wherein the pair of guide ribs are disposed on the inner surface of the tape feature and forms a generally arcuate surface.

4. The connector housing assembly as set forth in claim 2, wherein a first tape stop is disposed adjacent the distal end of the tape feature.

5. The connector housing assembly as set forth in claim 1, wherein the tie feature includes a slot with an open end so as to facilitate tying the wire bundle to the dress cover.

6. The connector housing assembly as set forth in claim 5, wherein the tie feature includes a tie housing, the tie housing has a generally arcuate outer surface and includes a support portion and a leg portion.

7. The connector housing assembly as set forth in claim 6, wherein the support portion is fixed to the first side wall and the leg portion is disposed beneath the support portion, an inner wall surface of the leg portion is spaced apart from the support portion and the wall so as to define the slot with an open end.

8. The connector housing assembly as set forth in claim 7, wherein the leg portion further includes a catch configured to retain a tie in the slot.

9. The connector housing assembly as set forth in claim 1, wherein the tape feature is a first and second tape feature and the tie feature is a first and second tie feature, and wherein exit path is a first exit path and a second exit path, the first exit path between the first back wall and the first side wall, the second exit path between the first back wall and the second side wall, wherein the first tape feature is adjacent the first exit path and the second tape feature is adjacent the second exit path, the first tie feature is disposed on the first side wall and the second tie feature is disposed on the second side wall.

10. A dress cover configured to provide multiple routing options for a wire, the dress cover comprising:
a first side wall, a second side wall, a first back wall and a first top wall connected to each other so as to define a storage space for accommodating the wire, the dress cover further including an exit path disposed between the first back wall and the first side wall, the exit path defines a path for which the wire is routed; and
a tape feature and a tie feature, the tape feature is a generally elongated and planar member extending from an outer peripheral side of the back wall, orthogonal to the plane of the first side wall and is coplanar with the exit path, the tie feature is mounted on the first side wall and is spaced apart from the back wall, the tie feature adjacent the exit path and above a plane of the exit path, the tie feature is disposed above the plane of the exit path so as to position a tied wire bundle along the plane of the exit path and parallel to the first side wall, accordingly, the dress cover provides multiple wire routing options for the wire.

11. The connector housing assembly as set forth in claim 10, wherein the tape feature includes a pair of guide ribs extending along an axial length of the elongated member.

12. The dress cover as set forth in claim 11, wherein the pair of guide ribs are disposed on the inner surface of the tape feature and forms a generally arcuate surface.

13. The dress cover as set forth in claim 11, wherein a first tape stop is disposed adjacent the distal end of the tape feature.

14. The dress cover as set forth in claim 10, wherein the tie feature includes a slot with an open end so as to facilitate tying the wire bundle to the dress cover.

15. The dress cover as set forth in claim 14, wherein the tie feature includes a tie housing, the tie housing has a generally arcuate outer surface and includes a support portion and a leg portion.

16. The connector assembly as set forth in claim 15, wherein the support portion is fixed to the first side wall and the leg portion is disposed beneath the support portion, an inner wall surface of the leg portion is spaced apart from the support portion and the wall so as to define the slot with an open end.

17. The connector housing assembly as set forth in claim 16, wherein the leg portion further includes a catch configured to retain a tie in the slot.
